(19) United States
(12) Patent Application Publication
(10) Pub. No.: US 2014/0034858 A1
(43) Pub. Date: Feb. 6, 2014

(54) VALVE ACTUATOR FOR ROTARY VALVE

(71) Applicant: Trenton F. Jackson, Marshalltown, IA (US)

(72) Inventor: Trenton F. Jackson, Marshalltown, IA (US)

(73) Assignee: Fisher Controls International LLC, Marshalltown, IA (US)

(21) Appl. No.: 13/563,217

(22) Filed: Jul. 31, 2012

(51) Int. Cl. F16K 31/50

(52) U.S. Cl. 251/296

(57) ABSTRACT

A valve actuator for a rotary valve includes a piston and housing assembly, wherein axial movement of the piston along a bore of the housing causes an actuator rod to twist or rotate about an axis of the bore. The rotary motion of the actuator rod is caused in some arrangements by axial rotation of the piston along a helical housing wall and/or by axial rotation of a generally helical shape of the actuator rod engaged with a central opening through the piston.

### BACKGROUND

1. Field of the Invention

The present invention relates generally to a valve assembly and a valve actuator for a rotary valve.

2. Description of the Background

Most valves can be categorized into two main general types: linear valves and rotary valves. Linear valves have a flow control member that is opened and closed by moving a valve shaft along a linear path, thereby moving the flow control member back and forth within the valve body. Rotary valves have a valve shaft, which is connected to a flow control member that is opened and closed by rotating the flow control member within the valve body.

Many valve actuators have a drive mechanism that creates rectilinear, or axial motion. Typical examples of some drive mechanisms include hydraulic or pneumatic pistons, diaphragm actuators, and bellows. Therefore, to use an actuator with a rectilinear drive mechanism to actuate a rotary valve, it is common to include a linkage system to convert the axial motion of the actuator into the rotary motion required to open and close the flow control member.

One common known exemplary valve actuator, shown diagrammatically in FIG. 1, is a spring and diaphragm pneumatic actuator. The valve actuator 10 includes an actuator housing 12 divided into two compartments 14, 16, by a flexible diaphragm assembly 18. A rigid diaphragm plate 20 is connected to the flexible diaphragm and an actuator rod 22, and a spring 24 biases the diaphragm plate in a first direction. Air is selectively injected into the compartment 14 opposite the spring 24 to force the diaphragm 18 and the actuator rod 22 axially in a second direction opposite the first direction. In order to convert the axial motion of the actuator rod 22 into rotary motion necessary to open or close a flow control member 26 of a rotary valve 28, a lever linkage 30 connects a valve shaft 32 with the actuator rod 22. The lever linkage 30 converts the axial movement of the actuator rod 22 into the necessary rotary movement of the valve shaft 32.

Another common known exemplary valve actuator 40, shown diagrammatically in FIG. 2, has a rack-and-pinion linkage between the actuator drive mechanism (not shown) and the valve shaft 32. Axial motion produced by a known drive mechanism is converted into rotary motion to open and close the flow control member 26 by the movement of a rack gear 42 past a pinion gear 44.

Although each of the known valve actuators 10, 40 described above is adequate to open and close a rotary valve, the housings of the actuators are often bulky and/or require a relatively large amount of space next to the valve. However, in many industrial settings, such as refineries, power plants, or chemical processing plants, space is often quite limited.

### SUMMARY

According to one exemplary aspect, a valve assembly includes a rotary valve having a flow control member and a valve shaft arranged such that rotation of the valve shaft opens and/or closes the flow control member. A valve actuator is arranged to rotate the valve shaft. The valve actuator includes a housing having an inner housing wall defining a bore through the housing, and a piston slidably engaging the inner housing wall and disposed inside the bore. The bore has a first axis. The piston is able to slide along the first axis between a first position and a second position. The inner housing wall is arranged to control rotary movement of the piston as the piston slides along the first axis of the bore between the first position and the second position. An actuator rod defining a second axis is disposed in the bore. The actuator rod extends through the piston and is coupled to the valve shaft. Axial movement of the piston along the first axis between the first position and the second position causes the actuator rod to rotate and open and/or close the flow control member.

According to another exemplary aspect, a valve actuator includes a cylinder having an inner housing wall defining a bore through the cylinder. The bore defines a first longitudinal axis. A piston slidably engaging the inner housing wall is disposed inside the bore. The piston is slidable along the first longitudinal axis between a first position and a second position. The inner housing wall is arranged to control rotary movement of the piston as the piston slides along the first longitudinal axis between the first position and the second position. An actuator rod is disposed in the bore. The actuator rod has a second longitudinal axis. The actuator rod extends through the piston and is arranged to be coupled to a valve shaft of a rotary valve. The piston is arranged to slide along the actuator rod between the first and second positions. Axial movement of the piston along the bore between the first and second positions causes the actuator rod to rotate about the second longitudinal axis.

According to a further exemplary aspect, a method of opening and/or closing a flow control member of a rotary valve is disclosed. The rotary valve has a flow control member and a valve shaft arranged such that rotation of the valve shaft with a valve actuator opens and/or closes the flow control member. The valve actuator includes a housing forming a bore about an axis, the bore having a non-circular axial cross-sectional periphery, a piston complementary to the bore and disposed inside the bore, the piston translating along the axis of the bore from a first position to a second position, and an actuator rod disposed in the bore and extending through the piston, the actuator rod operatively coupled with the valve shaft. At least one of the bore and the actuator rod has a helical shape arranged to cause the actuator rod to rotate in response to axial movement of the piston along the axis. The method includes the steps of urging the piston in a first direction along the axis, rotating the actuator rod and the valve shaft in a first angular direction in response to movement of the piston in the first direction, opening the flow control member in response to the rotation of the valve shaft in the first angular direction, urging the piston in a second direction along the axis opposite the first direction, rotating the actuator rod and the valve shaft in a second angular direction in response to the movement of the piston in the second direction, and closing the flow control member in response to the rotation of the valve shaft in the second angular direction.

In further accordance with any one or more of the foregoing exemplary aspects, a valve assembly, valve actuator, and/or method further optionally may include any one or more of the following preferred forms.

In some preferred forms, the bore may have a tubular shape. The piston may translate along the first longitudinal axis without rotating. The actuator rod may rotate in relation to the piston as the piston translates along the first longitudinal axis. The actuator rod may have a helical shape. The actuator rod may extend through an opening in the piston, the opening having a first radial angular position on a first side of the piston and a second radial angular position on a second side of the piston. The opening may rotate the rod as the piston slides between the first and second positions.

In some preferred forms, the tubular bore may have a non-circular outer periphery in a plane orthogonal to the first longitudinal axis. The outer periphery of the bore may have three corners and may be generally triangular. In other preferred forms, the outer periphery of the bore may have four corners, and may be generally rectangular or square. The piston may have a generally triangular, rectangular, or square annular edge that is complementary to the outer periphery of the tubular bore.

In some preferred forms, the actuator rod may have a non-circular rod cross-section. The opening of the piston may be shaped complementary to the rod cross-section. The opening may be aligned at a first angular orientation relative to the second longitudinal axis on a first side of the piston. The opening may be aligned at a second angular orientation relative to the second longitudinal axis on a second side of the piston.

In some preferred forms, the bore may have a helical shape. The piston may translate and rotate along the longitudinal axis. The actuator rod may be rotationally fixed in relation to the piston as the piston travels along the actuator rod such that the rod rotates with the piston. The inner housing wall may have a non-circular axial cross-sectional inner periphery shaped to define the helical shape of the bore along the longitudinal axis.

In some preferred forms, the piston divides the bore into a first chamber on a first side of the piston and a second chamber on a second side of the piston opposite the first side. Each of the first and second chambers may be enclosed and vary in volume as the piston travels along the stroke. A first fluid port may open into the first chamber. A second fluid port may open into the second chamber. The fluid ports may be arranged to be operatively connected with at least one pressurized air source to selectively inject air into either or both of the first and/or second chambers to selectively move the piston in opposite directions along the actuator rod. A spring may be disposed in the second chamber. The spring may be arranged to urge the piston toward the first chamber, and the first fluid port may be operatively connected with a pressurized air source to inject air into the first chamber to move the piston toward the second chamber.

Other aspects and forms will become apparent upon consideration of the following detailed description.

### BRIEF DESCRIPTION OF THE DRAWINGS

FIG. 1 is a cutaway view of a rotary valve and valve actuator according to the prior art;

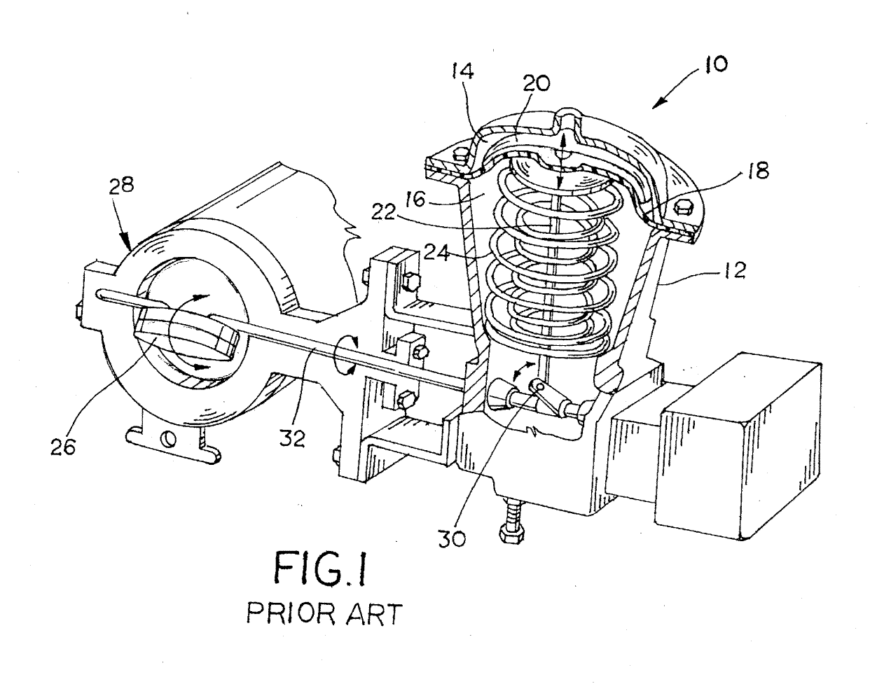

FIG. 2 is a cutaway view of another prior art valve actuator for a rotary valve;

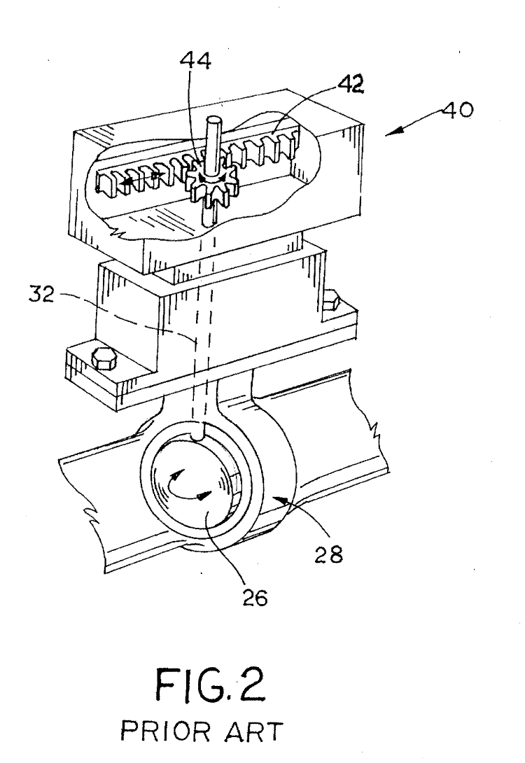

FIG. 3 is a partial cutaway isometric view of a rotary valve with a valve actuator according to some aspects of the present invention;

FIG. 4 is a side view in partial cross-section of a valve and valve actuator according to principles of the present disclosure along the lines 4-4 of FIG. 3;

FIG. 5 is an exploded assembly view of the valve actuator of FIG. 3;

FIG. 6 is a side view in partial cross-section of another valve actuator and rotary valve according to additional aspects of the present disclosure;

FIGS. 7A-7B show a partial cutaway view along the line 7-7 of the valve actuator of FIG. 6 with a piston in a first position in FIG. 7a and second position in FIG. 7b.

### DETAILED DESCRIPTION

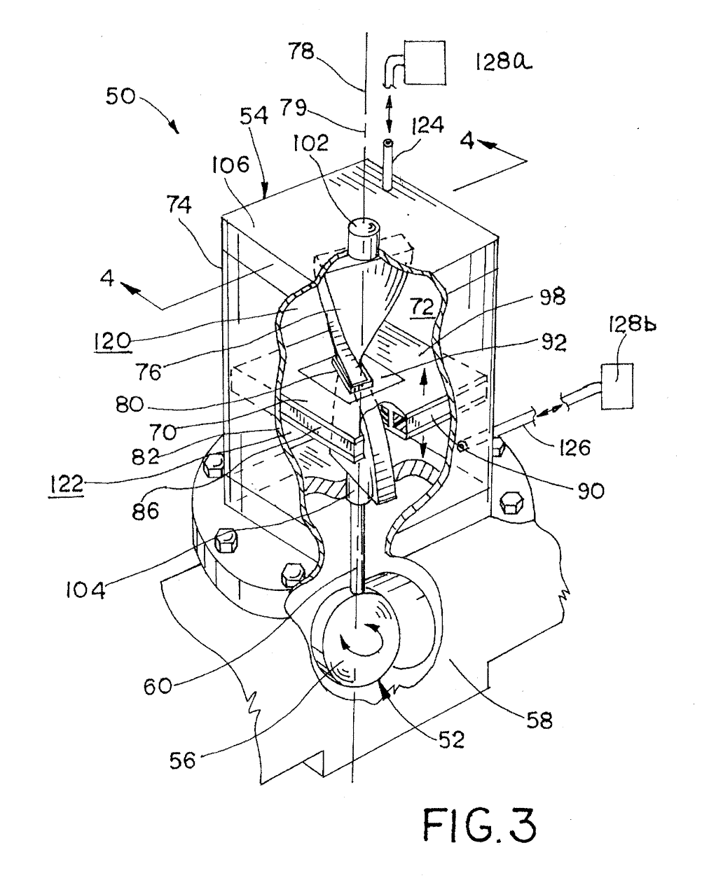

Turning now to FIGS. 3-5 a valve assembly 50 includes a rotary valve 52 and a valve actuator 54 operatively coupled to the rotary valve and arranged to rotate the valve between an open position and a closed position. The rotary valve 52 includes a flow control device 56, such as a disk or ball, disposed within a valve body 58, which defines a flow passage between a valve inlet and a valve outlet in a manner well understood in the art. A valve shaft 60 is connected to the flow control device 56 and extends upwardly out of the valve body 58 through appropriate valve packing, bonnet, etc. (All directional modifiers such as up, down, left, right, etc. are used for ease of understanding with reference to the drawings and do not otherwise limit the scope of the disclosure.) The valve shaft 60 is in the form of a elongate shaft, such as a straight rod, having an axis and a first end connected to the flow control device 56 and a second end extending outside of the valve packing. Thus, the flow passage within the valve body 58 may be opened by turning the valve shaft 60 and the flow control device 56 in a first direction about the axis of the valve shaft 60, such as clockwise, and the flow passage may be closed by turning the valve shaft 60 and the flow control device 56 in the opposite direction about the axis, usually 90 degrees, as is well understood in the art.

The valve actuator 54 includes a piston 70 disposed within a bore 72 of a actuator housing 74 and arranged to slide in translation up and down through the bore in an axial direction. The valve actuator 54 is arranged to convert linear axial motion of the piston 70 to rotary motion of the valve shaft 60. A helical actuator rod 76 extends along an axis 78 of the bore 72 and through a centrally located opening 80 through the piston 70. The helical actuator rod 76 is coupled to the valve shaft 60 in any manner sufficient to allow rotation of the actuator rod to also rotate the valve shaft 60 and/or open and/or close the flow control device 56. Preferably, an axis 79 of the helical actuator rod 76 is aligned and/or coaxial with the axis 78 of the bore. The piston 70 is also arranged to slide axially up and down along the helical actuator rod 76 simultaneously as sliding along the bore 72. Preferably, the piston 70, the bore 72, and the helical actuator rod 76 are arranged such that axial movement of the piston 70 along the bore 72 causes the helical actuator rod 76 to rotate about the axis 79 and/or the axis 78, and thereby open and/or close the flow control device 56.

The actuator housing 74 has a housing wall 82 that defines the bore 72. The housing wall 82 and bore 72 are shaped in any manner sufficient to control axial rotation of the piston 70 to either rotate or not rotate, as desired, as the piston 70 moves in translation along the axes 78 and/or 79. In a preferred arrangement, the bore 72 has a non-circular cross-section 84. In the embodiment shown in FIGS. 3-5 the housing wall 82 defines an elongate square or rectangular tubular bore; however, other non-circular shape bores may also be used according to the principles of the disclosure, such as triangular, oval, moon-shaped, clover-shaped, star-shaped, etc., as long as the housing wall 82 can control rotary motion of the piston 70 about the axes 78 and/or 79 as will be described in further detail below.

The piston 70 has a peripheral edge 86 that is complementary to the cross-sectional shape of the bore 72. In the depicted arrangement, the piston 70 has a rectangular outer peripheral edge 86 such that the piston 70 spans completely across the bore 72, and the peripheral edge 86 sealingly engages against the entire inner cross-sectional periphery of the housing wall 82.

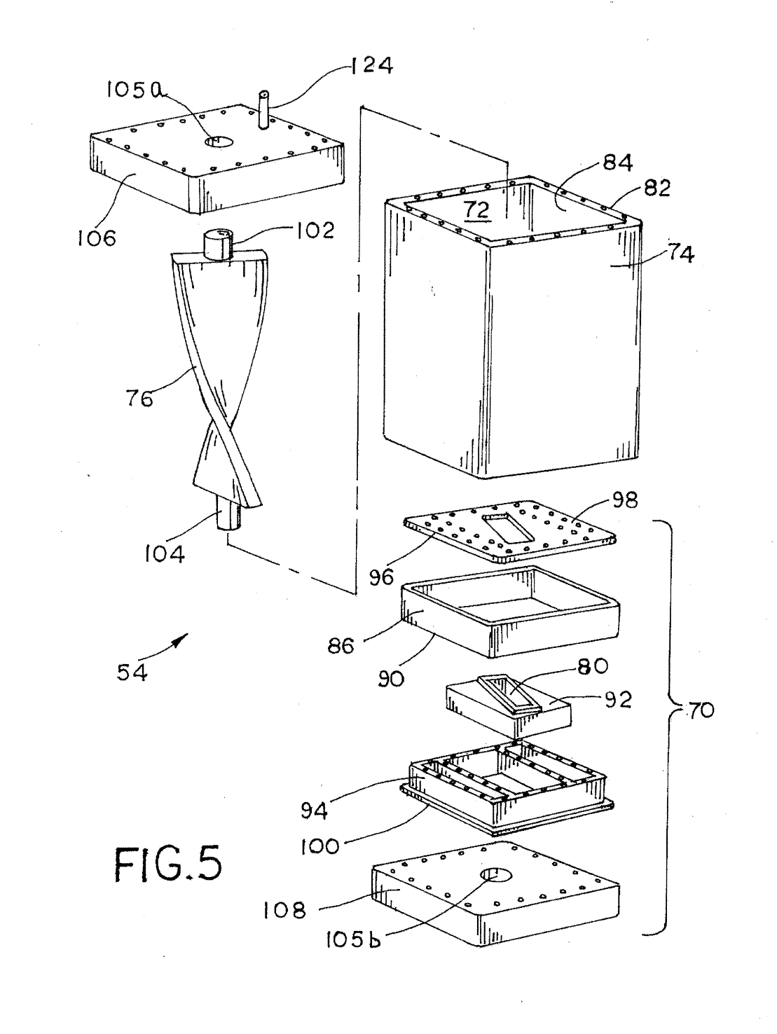

As best seen in FIG. 5, the piston 70 includes in one embodiment an outer seal 90 that seals against the housing wall 82, an inner seal 92 that defines the opening 80 and sealingly surrounds the actuator rod 76, a core 94 that receives the inner seal 92 and the outer seal 90, and a cover plate 96 that is attached to the piston core and retains the outer seal 90 and the inner seal 92 in position on the piston core 94. The outer seal 90 forms a fluid-tight seal between the piston 70 and the housing wall 82 to contain pressure in the upper and/or lower chambers 120, 122 descried hereinafter. The outer seal 90 surrounds the outer peripheral edge 86 of the piston. The outer seal 90 may be, for example, an O-ring and optionally may have the form of a flat strip or band. The cover plate 96 defines a first side 98 of the piston, the piston core 94 defines a second side 100 of the piston opposite the first side, and the outer seal 90 and inner seal 92 are held sandwiched therebetween, such as by clamping or with mechanical fasteners. For reasons explained hereinafter, the opening 80 preferably defines a bore that extends through the piston 70 and includes a helical twist along the axes 78 and/or 79, such that the opening 80 has a first radial angular alignment relative to the axis 79 through the first side 98 of the piston and a second radial angular alignment relative to the axis 79 through the second side 100 of the piston, wherein the second radial angular alignment is angularly offset from the first radial angular alignment in a plane perpendicular to the axis 79. Preferably, the opening 80 is in the form of an elongate slot, such as a rectangle, having a helical angular twist of about 1°-15° from the first side 98 to the second side 100. The cover plate 96 can be attached to the piston core 94 by any convenient mechanisms, such as screws, bolts, welding, glue, etc.

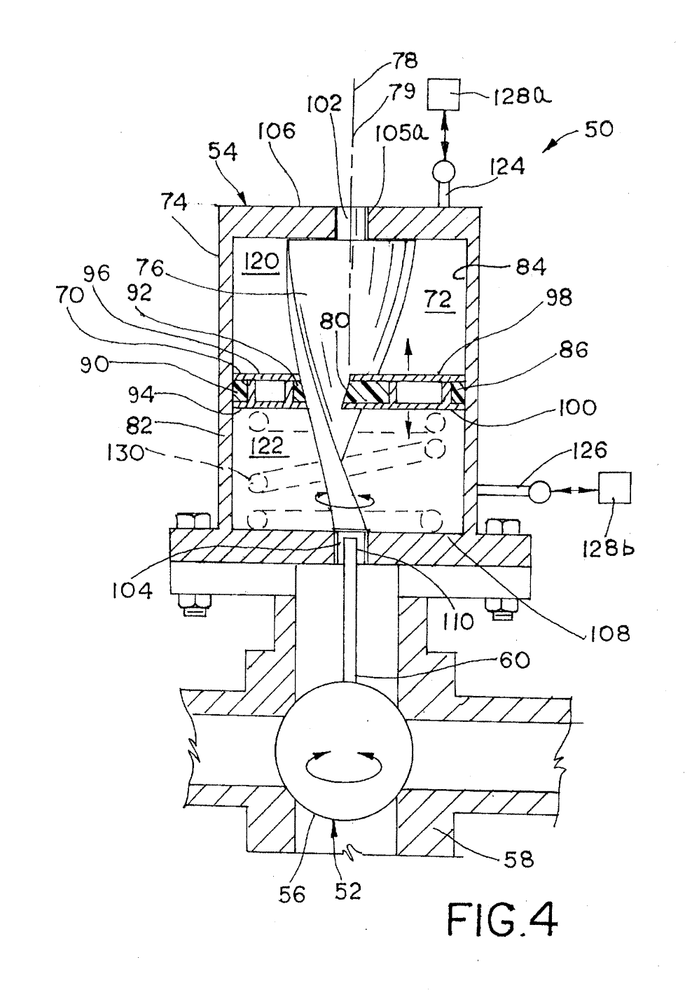

The helical actuator rod 76 has a twisted shape along the axis 78, preferably in a spiral shape. In the depicted arrangement, the helical actuator rod 76 is in the form of a rectangular bar having a rectangular axial cross-section with a width and a thickness, and length along the axis 78, wherein the rectangular cross-section of the bar twists along its length through an angle of approximately 90 degrees between opposite upper and lower ends of the bar, thereby forming the spiral or helical shape. Studs 102, 104, preferably in the form of cylindrical sections, project from the opposite ends of the helical actuator rod 76. The stud 102 is rotatably disposed within an axial bore 105a in an upper plate 106 covering the top end of the actuator housing 74, and the stud 104 is rotatably disposed in an axial bore 105b in a lower plate 108 disposed at the bottom end of the actuator housing 74. Bushings and/or bearings may be carried by the studs 102, 104 and/or within the axial bores 105a, 105b if desired in order to facilitate easy rotation of the actuator rod 76 about the axis 78. The studs 102, 104 are aligned with the axis 79 of the actuator rod 76, and preferably the axis 78 of the bore 72. The stud 104 preferably includes a connector for direct attachment to the valve shaft 60, such as a square socket 110 (best seen in FIG. 4) that receives a square end of the valve shaft 60, such that the valve shaft 60 is rotated by rotation of the helical actuator rod 76. However, the helical actuator rod 76 may be operatively connected to the valve shaft 60 by other and/or additional connectors.

The upper and lower plates 106, 108 completely cover the respective upper or lower end of the bore 72, preferably forming a pressure seal thereon. The upper and lower plates 106, 108 may be integral with the housing wall 82 or may be removably attached to the housing wall 82 by fasteners, such as bolts, welding, and/or adhesive.

The piston 70 divides the bore 72 into an upper chamber 120 and a lower chamber 122. Each chamber 120, 122 varies in volume as the piston 70 slides along the helical actuator rod 76 along its stroke along the axis 78 and is preferably substantially sealed to allow fluid pressure to accumulate and act upon the piston 70. The upper chamber 120 is adjacent and partly defined by the first side 98 of the piston and the lower chamber 122 is adjacent and partly defined by the second side 100 of the piston. As the piston 70 moves upwardly to a first position adjacent the upper plate 106, the volume of the upper chamber 120 decreases and the volume of the lower chamber 122 increases. As the piston 70 moves downwardly to a second position adjacent the lower plate 108, the volume of the lower chamber 122 subsequently decreases and the volume of the upper chamber 120 increases.

In order to actuate the movement of the piston 70 up and/or down along the axis 78, a fluid port 124 is in fluid communication with the upper chamber 120, such as through the upper plate 106, and a fluid port 126 is in fluid communication with the lower chamber 122, such as through the housing wall 82. Each fluid port 124, 126 is operationally connected with a pressurized supply line 128a, 128b , such as a pneumatic supply line generated by a field device such as a FIELDVUE® digital valve controller provided by Fisher Controls International LLC of Marshalltown, Iowa (not shown). The supply lines 128, 128b drive a pressurized fluid, such as pressure air, into the respective upper and lower chambers 120, 122. To move the piston 70 upwardly to the first position, the supply line 128b injects pressurized fluid into the lower chamber 122 while fluid inside the upper chamber 120 is ejected through the fluid port 124, thereby forcing the piston 70 upwardly toward the upper plate 106. To move the piston 70 downwardly to the second position adjacent the lower plate 108, the supply line 128a injects pressurize fluid through the fluid port 124 into the upper chamber 120 while fluid is simultaneously ejected out the fluid port 126, thereby forcing the piston 70 downwardly toward the lower plate 108.

A spring 130 is optionally used to bias the piston 70 in at least one direction, such as toward the upper plate 106 as shown in FIG. 4. The spring 130 is preferably disposed inside the bore 72, such as in the lower chamber 122, and presses against the piston 70 and the opposing cylinder head, such as the lower plate 108. In other arrangements, the spring 130 is arranged to provide a contracting force rather than compressive force. Other biasing arrangements of the spring 130 may also be used within the general principles of the present disclosure.

As the piston 70 moves in translation along the axis 78 of the bore 72 along its sliding stroke, the helical actuator rod 76 is caused to rotate about the axes 78 and/or 79 due to the engagement between the opening 80 and the helical shape of the helical actuator rod 76. As the piston 70 moves toward the lower plate 106, the helical actuator rod 76, the valve shaft 60, and the flow control device 56 all will rotate in a first direction, and when the piston 70 moves or slides along the stroke along the axis 78 of the bore 72 toward the cylinder head 108, the helical actuator rod 76, valve shaft 60, and flow control device 56 will rotate in the opposite direction. Thus the valve actuator 54 transforms linear motion of the actuator, in the form of the stroke of the piston 70 along the actuator housing 74, into rotary motion needed to open and/or close the flow control device 56 without a lever linkage or gear linkage as in the prior art and can thereby save valuable space.

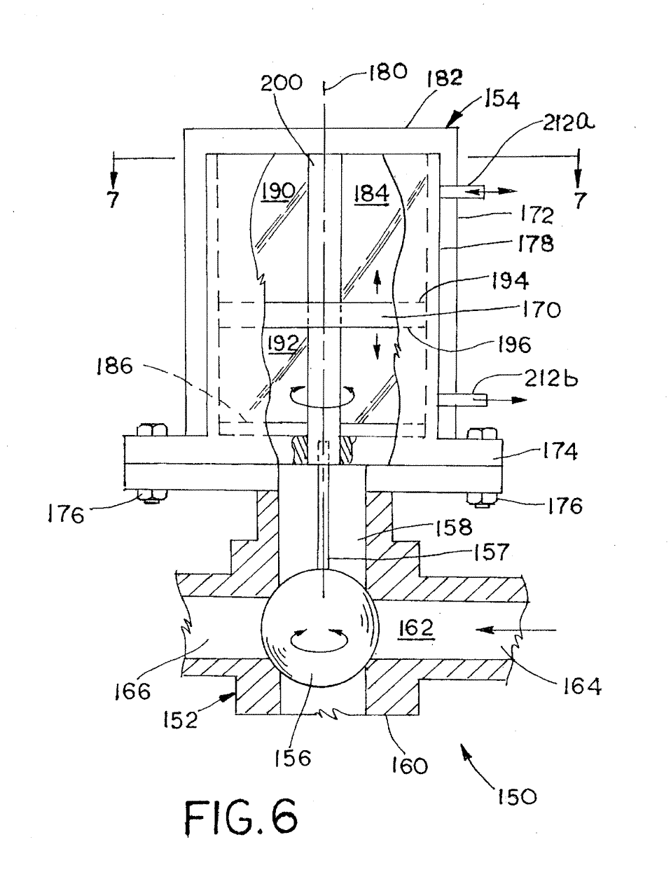

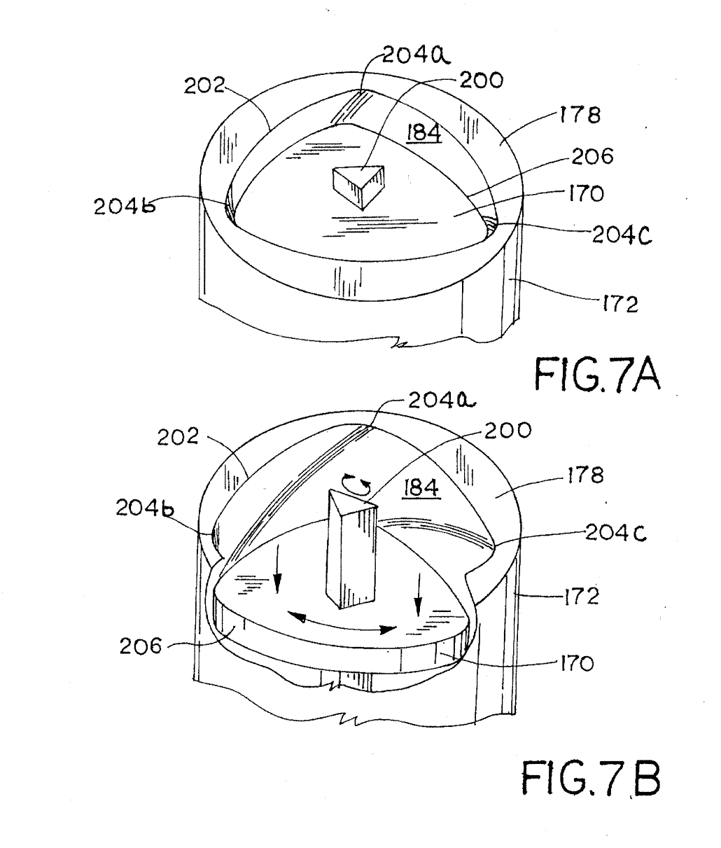

Turning now to FIGS. 6-7B, another valve assembly 150 is shown that incorporates additional principles of the present disclosure. The valve assembly 150 includes the rotary valve 152 operatively coupled to a valve actuator 154, wherein the valve actuator 154 is arranged to open and close the rotary valve 52. The rotary valve 152 includes a flow control device 156, such as a disk or ball, and a valve shaft 157 attached to the flow control device 156 and extending upwardly through a valve packing 158. The rotary valve 152 also includes a valve body 160 that defines a flow passage 162 extending between an inlet 164 and an outlet 166, wherein the flow control device 156 is disposed across the flow passage 162 and opens and/or closes by rotation within the flow passage 162. In one arrangement, the valve 152 is substantially identical to the valve 52.

The valve actuator 154 is disposed directly above the valve packing 158 and the valve shaft 157. The valve actuator 154 includes a piston 170 disposed inside a housing 172, which is attached to the valve packing 158 by means of a flange 174 connected to a bottom of the housing 172 and attached to the valve packing with fasteners 176, such as bolts. The valve actuator 154 is arranged to convert linear axial motion of the piston 170 to rotary motion of the valve shaft 157. The housing 172 further includes a housing wall 178 in the form of an annular wall extending upwardly from the flange 174 along an axis 180 to an upper housing plate 182 that covers a top end of the housing wall 178. The housing wall 178 defines a bore 184 coaxially aligned with the axis 180, in which the piston 170 slides up and down in translation along the axis 180 within the bore 184 a stroke length between a top position adjacent the cylinder head 182 and a bottom position adjacent the flange 174 or an optional lower housing plate 186 disposed across a bottom end of the housing wall 178.

Similar to the valve actuator 54, the piston 170 divides the bore 184 into an upper chamber 190 and a lower chamber 192, wherein a first side 194 of the piston faces the upper chamber 190 and the upper housing plate 182, and a second side of the piston 196 faces the lower chamber 192 and the lower housing plate 186. The volume of each of the upper chamber 190 and the lower chamber 192 varies as the piston 170 moves toward the cylinder head 182 or the cylinder head 186 within the bore during a stroke. In a preferred arrangement, the piston 170 includes an outer seal that sealingly engages the housing wall 178, and an inner seal that sealingly engages an actuator rod 200 that extends along the axis 180 within the bore 184, sandwiched between a cover plate and a piston core, all substantially similar to the piston 70 as previously described.

The actuator rod 200 is arranged to rotate about the axis 180 as the piston 170 moves along its stroke within the bore 184, such as up and/or down along the axis 180. As best seen in FIGS. 7A-7B, the bore 184 has a non-circular axial cross-sectional shape, i.e. a shape in the cross-sectional plane perpendicular to the axis 180, such as with an outer periphery 202 that is generally triangular, having three rounded or sharp corners 204a, 204b, 204c as shown in the drawings, or any other non-circular outer periphery as, for example, discussed previously herein. The piston 170 has a peripheral edge 206 that is complementary to the outer periphery 202 of the bore 184, and preferably forms a fluid-tight seal between the piston 170 and the housing wall 178 around the entire periphery of the piston 170. Unlike the valve actuator 54, however, the housing wall 178 is rifled, in that the corners 204a, 204b, 204c and the entire cross-sectional shape of the outer periphery 202 twist about the axis 180 along the length of the housing wall 178 between the cylinder head 182 and the cylinder head 186, thereby forming the bore 184 as a helical shape, such as a spiral. In this arrangement, the corners 204a-c form helical grooves extending along the radially inner surface of the housing wall 178. The grooves may also have the form of an angled flight. The helical shape preferably sweeps an angle of approximately 90 degrees around the axis 180 between the opposite ends of the housing wall 178. Thus as the piston 170 translates up or down along the axis 180 within the bore 184, the piston 170 also rotates about the axis 180 along the helical shape of the housing wall 178.

The actuator rod 200 has a non-circular axial cross-sectional shape, such as a triangular shape as shown in the figures, and the piston 170 has an opening 210 through a central portion of the inner seal, such as a triangular shape, complementary to the cross-sectional shape of the actuator rod 200. The piston 170 is arranged to slide axially along the actuator rod 200. Thus, as the piston 170 translates axially up or down within the bore 184 and rotates about the axis 180, the piston 170 also rotates the actuator rod 200 about the axis 180. In one arrangement, a bottom end of the actuator rod 200 is operatively coupled with the valve shaft 157, such as with a plug and socket connection as previously described herein or any other suitable connector, such that rotation of the actuator rod 200 also rotates the valve shaft 157 and thus rotates the flow control device 156 between the open and closed positions. For example as shown in FIG. 7A, at the top of the stroke adjacent the cylinder head 182, the piston 170 is at a first angular position with respect to the axis 180, and at the bottom of the stroke, as shown in 7B, the piston is at a second angular position with respect to the axis 180, preferably rotated 90 degrees from the first angular position.

The piston 170 may be urged axially back and forth within the bore 184 in any sufficient manner, such as with pneumatic or hydraulic pressure, or springs. In the depicted arrangement of FIG. 6, the valve actuator 154 is arranged to be actuated by pressurized fluid, such as pneumatic pressure or hydraulic pressure applied to the upper chamber 190 or a lower chamber 192. Thus fluid ports, 212a, 212b, such as nipples, are directed into each of the upper chamber 190 and the lower chamber 192. The fluid port 212a is directed into the upper chamber 190 and is adapted to be connected with a pressurized fluid as previously described such that pressurized fluid may be injected into the upper chamber 190 through the fluid port 212a to force the piston 170 down along the axis 180 toward the lower housing plate 186. Similarly the fluid port 212b is connected with the lower chamber 192 and adapted to be connected with a source of pressurized fluid, such as a compressor, and arranged such that pressurized fluid injected through the fluid 212b enters the lower chamber 192 and urges the piston 170 upwardly along the axis 180 toward the upper housing plate 182. Thereby, the piston 170 may be selectively actuated in either direction along the axis 180 by selectively injecting pressurized fluid through fluid port 212a or fluid port 212b, and thereby rotate the flow control device 156 to open and/or close the rotary valve 152.

Each of the valve actuators 54 and 154 described in detail herein is exemplary of one or more principles of the present disclosure as recited in the claims appended hereinafter. The valve actuators 54 and 154 can in some arrangements optionally eliminate geared or levered linkages previously used in actuators for rotary valves and thereby may in some arrangements be simpler and more compact than the previously known valve actuators. In some arrangements, the valve actuators may advantageously provide a more compact valve actuator for a rotary valve and/or otherwise require less space than other types of valve actuators. Of course, other uses, benefits, and advantages may also or alternatively be realized from the apparatus described in further detail below as would be apparent to a person of ordinary skill.

Numerous modifications to the valves and valve actuators disclosed herein will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

I claim:

1. A valve assembly comprising:
a rotary valve comprising a flow control member and a valve shaft arranged such that rotation of the valve shaft opens and/or closes the flow control member; and
a valve actuator arranged to rotate the valve shaft, the valve actuator comprising:
a housing having an inner housing wall defining a bore through the housing, the bore having a first axis;
a piston slidably engaging the inner housing wall and disposed inside the bore, the piston slidable along the first axis between a first position and a second position, wherein the inner housing wall is arranged to control rotary movement of the piston as the piston slides along the first axis between the first position and the second position; and
an actuator rod defining a second axis and disposed in the bore, the actuator rod extending through the piston and coupled to the valve shaft;
wherein axial movement of the piston along the first axis between the first position and the second position causes the actuator rod to rotate and open and/or close the flow control member.

2. The valve assembly of claim 1, wherein the bore has a tubular shape, the piston translates along the first axis without rotation, and the actuator rod rotates in relation to the piston.

3. The valve assembly of claim 2, wherein the actuator rod has a helical shape.

4. The valve assembly of claim 3, wherein the actuator rod extends through an opening in the piston, the opening having a first radial angular position on a first side of the piston and a second radial angular position on a second side of the piston.

5. The valve assembly of claim 1, wherein the bore has a helical shape, the piston translates and rotates along the first axis, and the rod rotates with the piston.

6. The valve assembly of claim 5, wherein the actuator rod is rotationally fixed in relation to the piston as the piston travels along the actuator rod, wherein the inner housing wall has a non-circular axial cross-sectional inner periphery and is shaped such that the bore has a helical shape along the first axis.

7. A valve actuator comprising:
a cylinder having an inner housing wall defining a bore through the cylinder, the bore defining a first longitudinal axis;
a piston slidably engaging the inner housing wall and disposed inside the bore, the piston slidable along the first longitudinal axis of the bore between a first position and a second position, wherein the inner housing wall is arranged to control rotary movement of the piston as the piston slides along the first longitudinal axis between the first position and the second position; and
an actuator rod having a second longitudinal axis and disposed in the bore, the actuator rod extending through the piston and arranged to be coupled to a valve shaft of a rotary valve, and the piston arranged to slide along the actuator rod between the first and second positions;
wherein the piston and the rod are arranged such that axial movement of the piston along the bore between the first position and the second position causes the actuator rod to rotate about the second longitudinal axis.

8. The valve actuator of claim 7, wherein the actuator rod rotates in relation to the piston as the piston translates along the first longitudinal axis.

9. The valve actuator of claim 8, wherein the actuator rod has a helical shape, and wherein the piston defines an opening that receives the helical shape and rotates the rod as the piston slides between the first and second positions.

10. The valve actuator of claim 9, wherein the actuator rod has a rod cross-section, and the opening of the piston is shaped complementary to the rod cross-section, wherein the opening is aligned at a first angular orientation relative to the second longitudinal axis on a first side of the piston and the opening is aligned at a second angular orientation relative to the second longitudinal axis on a second side of the piston.

11. The valve actuator of claim 9, wherein the inner housing wall defines a tubular bore, the tubular bore having an outer periphery in a plane orthogonal to the first longitudinal axis, the outer periphery being non-circular, and the piston translates along the first longitudinal axis without rotating.

12. The valve actuator of claim 11, wherein the inner housing wall forms a rectangular tubular bore, and the piston has a rectangular annular edge that is complementary to the rectangular tubular bore.

13. The valve actuator of claim 7, wherein the piston divides the bore into a first chamber on a first side of the piston and a second chamber on a second side of the piston opposite the first side, each of the first and second chambers being enclosed and varying in volume as the piston travels along the stroke, further comprising a first fluid port opening into the first chamber and a second fluid port opening into the second chamber, the fluid ports arranged to be operatively connected with at least one pressurized air source to selectively inject air into the first or second chambers to selectively move the piston in opposite directions along the actuator rod.

14. The valve actuator of claim 7, wherein the piston divides the bore into a first chamber on a first side of the piston and a second chamber on a second side of the piston opposite the first side, each of the first and second chambers being enclosed and varying in volume as the piston travels along the first longitudinal axis, further comprising a first fluid port opening into the first chamber, and a spring disposed in the second chamber, wherein the spring is arranged to urge the piston toward the first chamber, and the first fluid port is arranged to be operatively connected with a pressurized air source to inject air into the first chamber to move the piston toward the second chamber.

15. The valve actuator of claim 7, wherein the piston rotates in relation to the cylinder as the piston travels along the first longitudinal axis.

16. The valve actuator of claim 15, wherein the actuator rod is rotationally fixed in relation to the piston as the piston travels along the first longitudinal axis.

17. The valve actuator of claim 16, wherein the inner housing wall has a non-circular axial cross-sectional inner periphery and is shaped such that the bore has a helical shape along the first longitudinal axis.

18. The valve actuator of claim 17, wherein the outer periphery of the bore is has three corners.

19. A method of opening and/or closing a flow control member of a rotary valve comprising a flow control member and a valve shaft arranged such that rotation of the valve shaft with a valve actuator opens and/or closes the flow control member, the valve actuator comprising a housing forming a bore about an axis, the bore having a non-circular axial cross-sectional periphery, a piston complementary to the bore and disposed inside the bore, the piston translating along the axis of the bore from a first position to a second position, and an actuator rod disposed in the bore and extending through the piston and operatively coupled with the valve shaft, at least one of the bore and the actuator rod having a helical shape arranged to cause the actuator rod to rotate in response to axial movement of the piston along the axis, wherein the method comprises the steps:
urging the piston in a first direction along the axis;
rotating the actuator rod and the valve shaft in a first angular direction in response to movement of the piston in the first direction;
opening the flow control member in response to the rotation of the valve shaft in the first angular direction.

20. The method of claim 19, further comprising the steps:
urging the piston in a second direction along the axis opposite the first direction;
rotating the actuator rod and the valve shaft in a second angular direction in response to the movement of the piston in the second direction; and
closing the flow control member in response to the rotation of the valve shaft in the second angular direction.
